(19) United States
(12) Patent Application Publication
(10) Pub. No.: US 2023/0276984 A1
(43) Pub. Date: Sep. 7, 2023

(54) SANDWICH MAKER

(71) Applicant: Brush and Bristle Corp., Miami, FL (US)

(72) Inventors: Daniel L. FIGUEREDO, Miami, FL (US); Christian TRAVERT, Davie, FL (US)

(21) Appl. No.: 18/177,902

(22) Filed: Mar. 3, 2023

Related U.S. Application Data
(60) Provisional application No. 63/268,903, filed on Mar. 4, 2022.

(51) Int. Cl. A47J 37/06; B65G 15/14; A47J 36/32

(52) U.S. Cl. CPC A47J 37/0611; A47J 36/32; B65G 15/14; A47J 2037/0617; B65G 2811/097

(57) ABSTRACT

Disclosed is sandwich maker comprising top and bottom conveyor belts which transport a sandwich, or other food item suitable for simultaneous heating and compression inserted in one end of the apparatus to the other end of the apparatus. As the sandwich travels on the conveyor belts, the apparatus simultaneously compresses the sandwich and applies heat to both the top and the bottom sides of the sandwich so that it emerges from the sandwich maker fully cooked and ready to serve.

### CLAIM OF PRIORITY

This application is being filed as a non-provisional patent application under 35 U.S.C. §111(b) and 37 CFR §1.53(c). This application claims priority under 35 U.S.C. §119(e) to U.S. Provisional Pat. Application serial number 63/268,903 filed on Mar. 4, 2022, the contents of which are incorporated herein by reference.

### FIELD OF INVENTION

The invention relates generally to the field of food preparation devices. More specifically, the present invention is for a conveyor-type sandwich maker that simultaneously compresses and heats a sandwich as it travels along a system of conveyor belts.

### SUMMARY OF THE INVENTION

The disclosed sandwich maker comprises top and bottom, optionally teflon-coated, food-grade conveyor belts which transport a sandwich, or other food item suitable for simultaneous heating and compression (hereinafter interchangeably referred to as a “sandwich” or as a “food item”), inserted in one end of the apparatus to the other end of the apparatus. As the sandwich travels on the conveyor belts, the apparatus simultaneously compresses the sandwich and applies heat to both the top and the bottom sides of the sandwich so that it emerges from the sandwich maker fully cooked and ready to serve. The disclosed sandwich maker provides an improvement over traditional sandwich presses that can only heat one sandwich at a time.

The present invention comprises counter-rotating top and bottom conveyor belts that carry the sandwich accross top and bottom heating plates to fully cook, compress, and, if desired, toast the sandwich. The sandwich is placed on the bottom belt, which extends beyond the top belt, and enters the cooking area through a ramp-shaped opening that compresses the sandwich vertically. As the sandwich travels through the machine, it is cooked by the applied heat (top and bottom) and is kept compressed by pressure applied by the cooperating conveyor belts.

The top and bottom belts are driven by a series of rollers, including a system of tensioning rollers, for each top and bottom section. The rollers are driven by a motor which is connected to the drive rollers by chains, belts, or other similar devices that transfer rotary motion. In one embodiment, the motor is directly linked by a chain to a bottom roller. The bottom roller, in turn drives a pair of reversing gears through another chain, and the reversing gears are in turn connected via a chain to a top roller which drives the top belt in the reverse direction of the bottom belt. Since there is a single motor, and there ratio of gears throughout is 1:1, the top and bottom conveyors rotate at the same speed, one in a clockwise sense, the other counterclockwise. This allows the two belts to cooperate to smoothly transport a sandwich placed between them.

Two or more swing arms connect the top and bottom sections of the machine. Aided by an actuator, it is possible to swing the top portion of the apparatus to reverse the direction of operation of the device. This is useful to enable configuration of the device to fit the workflow of the kitchen where it is used in without requiring rotation of the entire device. The same actuator is used to adjust the separation between the top and bottom belts in order to accommodate different sized sandwiches, and to adjust the level of compression of the sandwich throughout the cooking process.

The device may be optionally equipped with components that facilitate the cleaning of the top and bottom belts as necessary. The cleaning components optionally comprise cleaning boxes with hot or cold water jets capable of continuously cleaning each of the belts while in use, or when the sandwich maker is is not in operation. The configuration of the cleaning boxes allows them to be removed and replaced without the need to remove the belts. The cleaning component may also optionally comprise one or more cleaning tanks with rollers that guide the top and/or bottom belt through a reservoir of cleaning fluid.

The device may optionally be equipped with one or more cameras capable of capturing images of sandwiches entering or exiting the device through either end. The cameras can capture images in the visible spectrum or in the infrared spectrum to determine temperature. The camera images can be processed for quality control and inventory control purposes. The camera images can, for example, be processed to determine the number of sandwiches inserted into, and exited from, the machine and thus determine the throughput of the apparatus. The images can also be analyzed, for example, to determine the degree of heat applied to each sandwich and whether the observed sandwich is cooked properly. The camera images can be observed in real time by an operator, or recorded for later review and analysis. In addition, real-time camera images can be used as part of a feedback system to adjust the various parameters of the machine (e.g., belt speed, heating temperatures, belt separation, etc.) to ensure optimal cooking of the food items.

The apparatus is equipped with a control panel and screen which are connected to a a controller that is used to adjust various parameters of the apparatus, such as the belt speed, belt direction, top to bottom belt distance, heating element temperatures, and the like. The controller is also electronically connected to the optional cameras and provides software and memory to analyze and store camera images.

Herein described is a sandwich maker comprising a top continuous loop conveyor belt having an outside surface; a top heating plate associated with the top continuous loop conveyor belt and adapted to heat a lower portion of the outside surface of the top continuous loop conveyor belt; a bottom continuous loop conveyor belt having an outside surface; a bottom heating plate associated with the bottom continuous loop conveyor belt and adapted to heat an upper portion of the outside surface of the bottom continuous loop conveyor belt; a motor adapted for simultaneously driving the top continuous loop conveyor belt in a first direction and the bottom continuous loop conveyor belt in a second direction, the second direction being the opposite of the first direction; a controller in electronic communication with the motor, the top heating plate, and the bottom heating plate, the controller adapted to control a speed and a direction of the motor, a temperature of the top heating plate, and a temperature of the bottom heating plate; a control panel adapted to interface with the controller; wherein the lower portion of the outside surface of the top continuous loop conveyor belt and the upper portion of the outside surface of the bottom continuous loop conveyor belt are disposed opposite each other and are separated by a gap; wherein the gap is adapted to receive a sandwich; wherein the lower portion of the outside surface of the top continuous loop conveyor belt and the upper portion of the outside surface of the bottom continuous loop conveyor belt are adapted to transport the sandwich across the top heating plate and the bottom heating plate, simultaneously heating a top surface of the sandwich and a bottom surface of the sandwich; and wherein the lower portion of the outside surface of the top continuous loop conveyor belt and the upper portion of the outside surface of the bottom continuous loop conveyor belt are also adapted to compress the sandwich as it is heated.

The construction of the invention, together with additional objects and advantages thereof will be best understood from the following description of the specific disclosed embodiments when read in connection with the accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a top front othrographic representation of the sandwich maker of the present invention fully assembled.

FIG. 2 is a top rear othrographic representation of the sandwich maker of the present invention fully assembled.

FIG. 3 is a top front othrographic representation of the sandwich maker of the present invention with selected panels removed, or shown transparent, to illustrate certain aspects of the sandwich maker.

FIG. 4 is a top rear orthographic representation of the sandwich maker of the present invention with selected panels removed, or shown transparent, to illustrate certain aspects of the sandwich maker.

FIG. 5 is a front cross-sectional representation of the sandwich maker of the present invention with selected panels removed, or shown transparent, to illustrate certain aspects of the sandwich maker.

FIG. 6 is a close up view of the drive elements of the top and bottom belts in accordance with the present invention.

FIG. 7 is a partial rear view representation of the sandwich maker of the present invention illustrating the swing motion for reversing the direction of the sandwich maker.

FIGS. 8A and 8B are orthographic top and cross sectional views of a cleaner tank in accordance with the present invention.

FIGS. 9A and 9B are orthographic top and bottom views of a cleaner box in accordance with the present invention.

FIGS. 10A and 10B are orthographic top and bottom views of a heating assembly in accordance with the present invention.

### DETAILED DESCRIPTION OF THE INVENTION

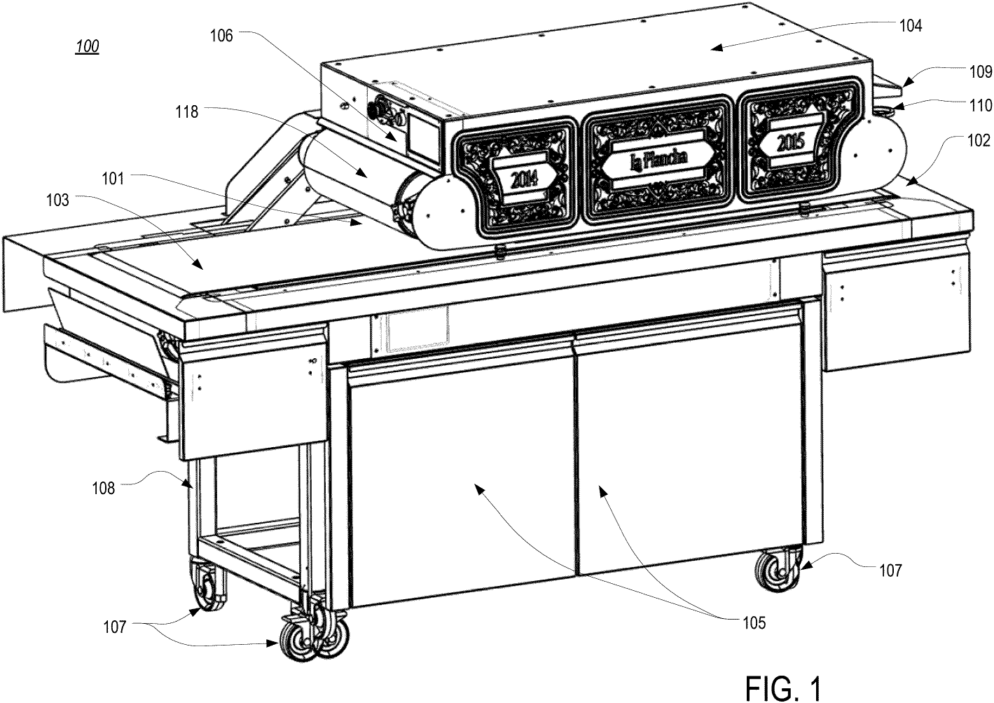

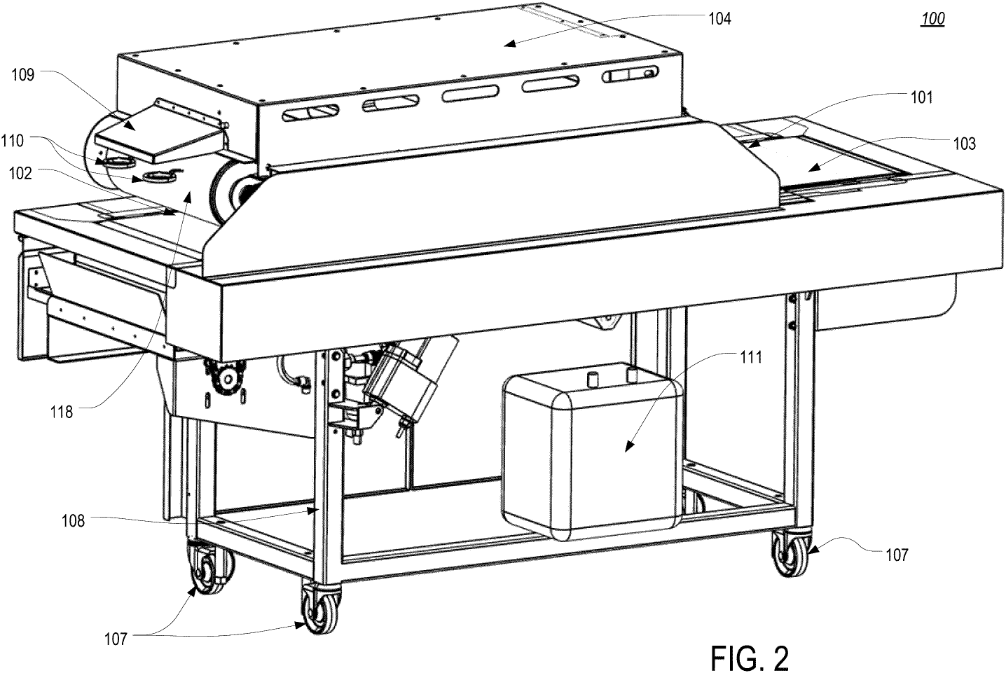

FIGS. 1 and 2 show front and rear orthographic views of the sandwich maker of the precent invention with all decorative, protective, and access panels, covers and doors installed. As many of the features of the device are obscured by these panels, covers, and doors, additional views are provided in subsequent figures with panels, doors, and covers selectively removed as necessary to illustrate the desired features.

The basic features of the sandwich maker (100) illustrated in FIGS. 1 and 2, include: sandwich entry (101), sandwich exit (102), bottom belt (103), top belt (118), hood (104), front doors (105), control panel and screen (106), wheels (107), stand frame (108), camera (109), camera lights (110), and a water heater (111).

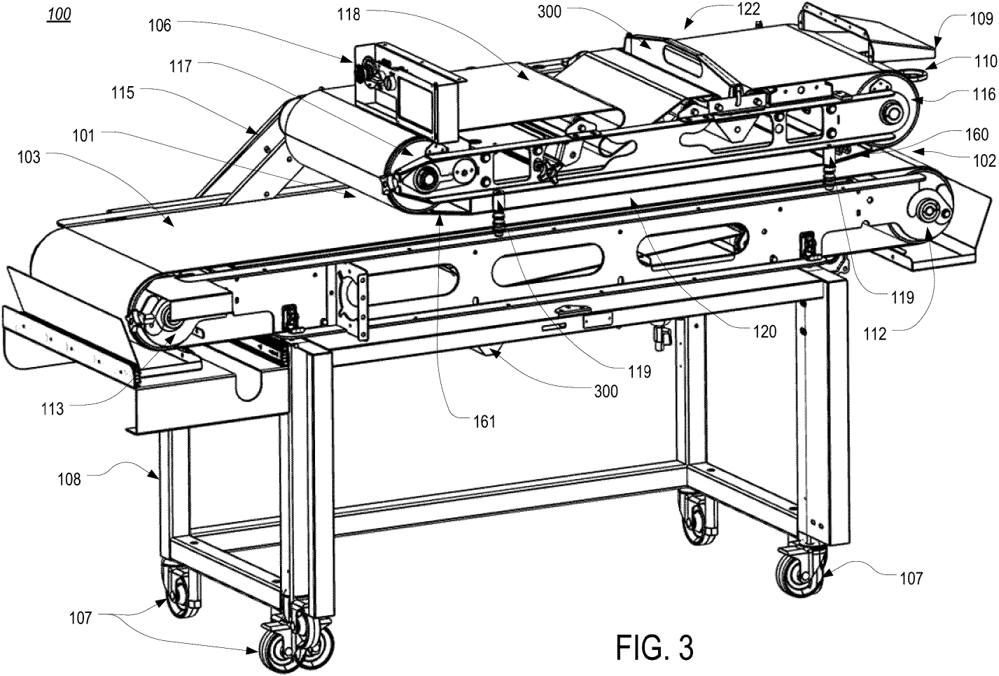

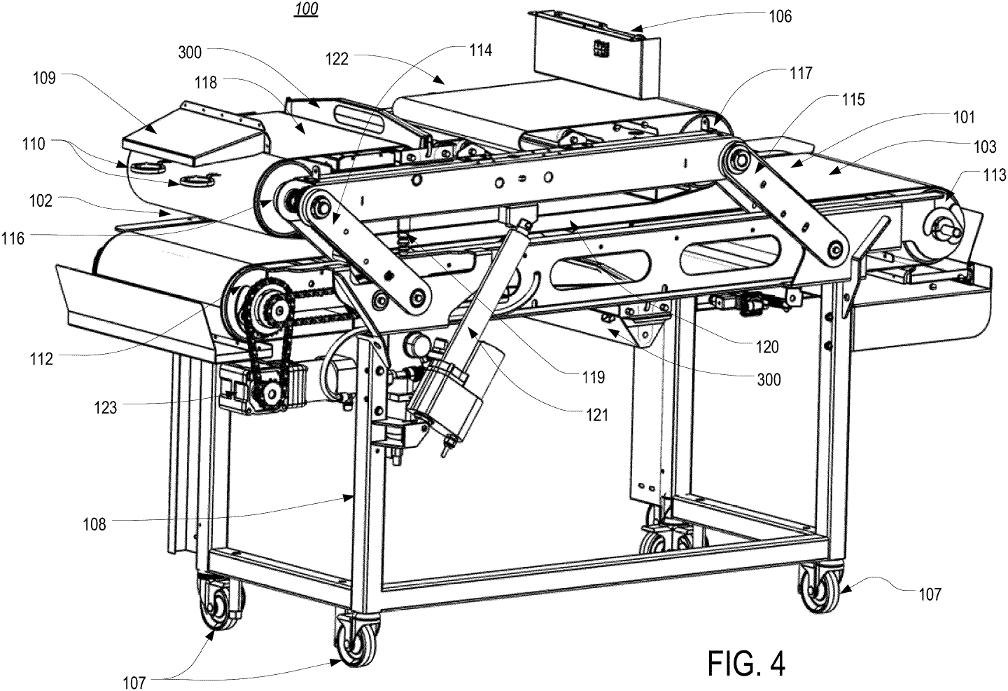

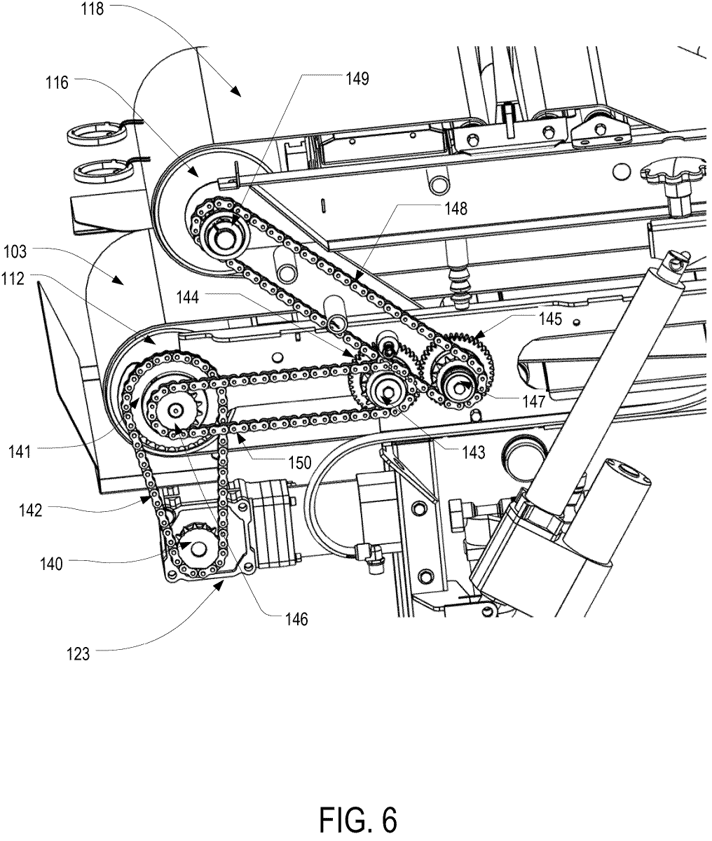

Referring now to FIGS. 3 and 4, which more clearly illustrate the features of the present invention, the sandwich maker (100) comprises a rectangular stand frame (108) comprised of various linear segments. The stand frame (108) is supported by wheels (107) at each bottom corner to facilitate movement of the device. The top portion of stand frame (108) supports first and second bottom belt rollers (112, 113 respectively) which in turn drive bottom belt (103). First and second swing arms (114, 115 respectively) extend from the top portion of stand frame (108) and support a top belt assembly (122) comprising first and second top belt rollers (116, 117 respectively) which in turn drive top belt (118). It will be noted that the upper surface of bottom belt (103) defines a substantially flat plane, while there are entry and exit ramps (160, 161 respectively) at the lower surface of top belt (118) which facilitate the gradual compression of food items entering the device. A motor (123) provides the power necessary for driving the top and bottom belts (118, 103) through a system of chains and gears which is detailed in FIG. 6 below. The speed and direction of the motor (123) is determined by a controller (not shown) which is accessed through control panel and screen (106).

A plurality of pegs (119) maintain a minimum separation (120) between the bottom surface of top belt (118) and the top surface of bottom belt (103). This minimum separation provides for the highest level of compression of food items prepared in the device. The separation (120) between the upper and lower belts can be adjusted above the minimum separation and thus reduce compression of food items or accept larger food items. This adjustment is accomplished by pivotally raising the top belt assembly (122) by using an actuator (121) disposed between stand frame (108) and top belt assembly (122). The actuator (121) can be an electrical, pneumatic, hydraulic, magnetic, or any other suitable actuator type. As the top belt assembly (122) is raised, it proceeds along an arc defined by the pivoting of swing arms (114,115) about their lower attachment points.

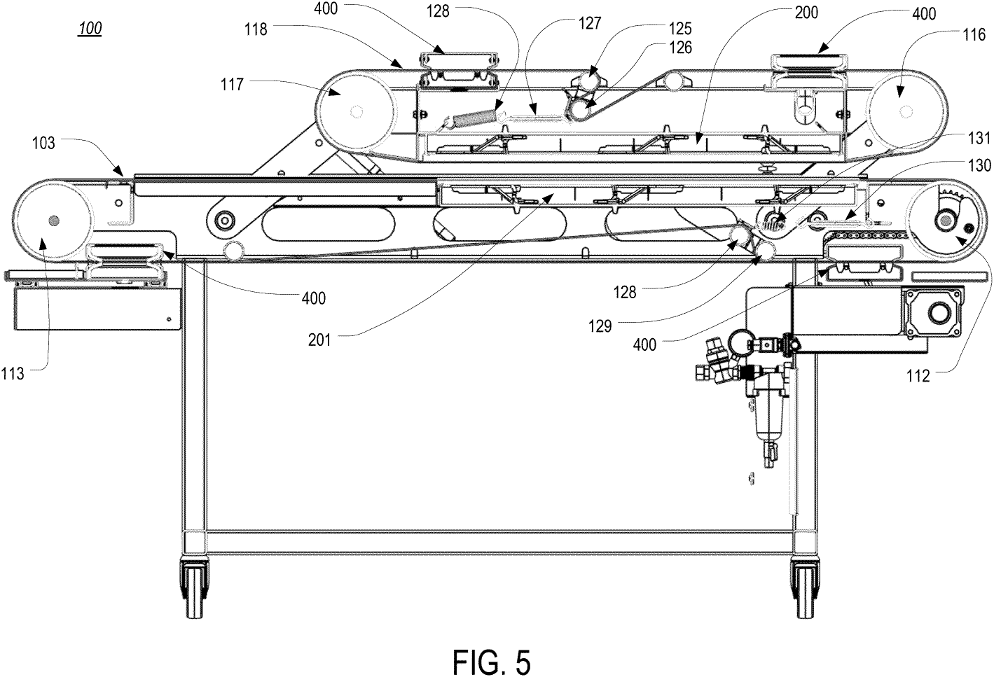

As a sandwich, or other food item, travels between the top and bottom belts (118, 103) compression is gradually increased by entry ramp (160) until the compression reaches a constant level (i.e., when the separation (120) between the top and bottom belts (118, 103) is constant). In an alternative embodiment, the top and bottom belts (118, 103) can be positioned so that the separation (120) between them gradually increases, or gradually decreases as the food item is cooked. In such alternative embodiments, compression would be gradually decreased or increased as the food item is cooked. While being pressed, the sandwich is simultaneously heated by top and bottom heating assemblies (200, 201 respectively), shown in FIG. 5, located immediately above the bottom surface of top belt (118), and immediately below the top surface of bottom belt (103).

An optional downward facing camera (109) captures images of sandwiches as they emerge from the device fully cooked and pressed. Camera lights (110) illuminate the sandwiches for clearer images. The camera (109) can capture images in the visible spectrum or in the infrared spectrum to determine temperature. Images from the camera can be processed for quality control and inventory control purposes. The images can, for example, be processed to determine the number of sandwiches inserted into, and exited from, the machine and thus determine the throughput of the apparatus. The images can also be analyzed, for example, to determine the degree of heat applied to each sandwich and whether each observed sandwich is cooked properly. The camera images can be observed in real time by an operator, or recorded for later review and analysis. In addition, real-time camera images can be used as part of a continuous feedback system to automatically adjust the various parameters of the device (e.g., belt speed, heating temperatures, belt separation, etc.) to ensure optimal cooking of the food items as environmental factors (air temperature, humidity, starting temperature of uncooked food items, and the like) vary.

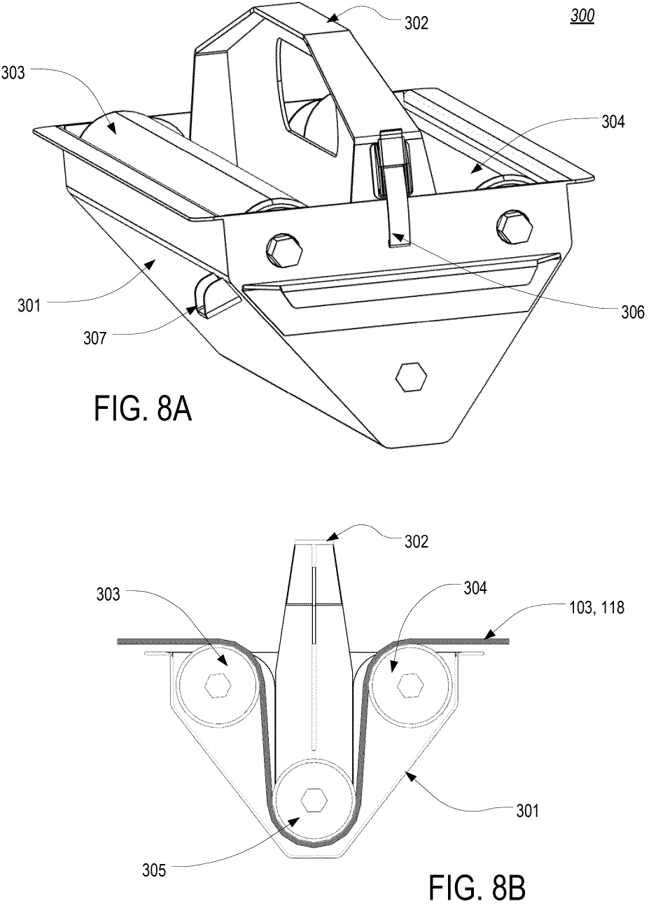

Also shown on FIGS. 3 and 4 are cleaner tanks (300) that may optionally be utilized in some embodiments of the invention. Cleaner tanks (300) comprise scrapers, a triangularly profiled sink, and internal rollers through which top and/or bottom belts (118,103) can weave and be guided through a cleaning fluid so as to continuously maintain the belts clean. Additional detail regarding the cleaner tanks are provided below and in FIGS. 8A and 8B. A water heater (111), shown in FIG. 2, can optionally provide hot water to be used as a cleaning fluid by the cleaner tanks (300).

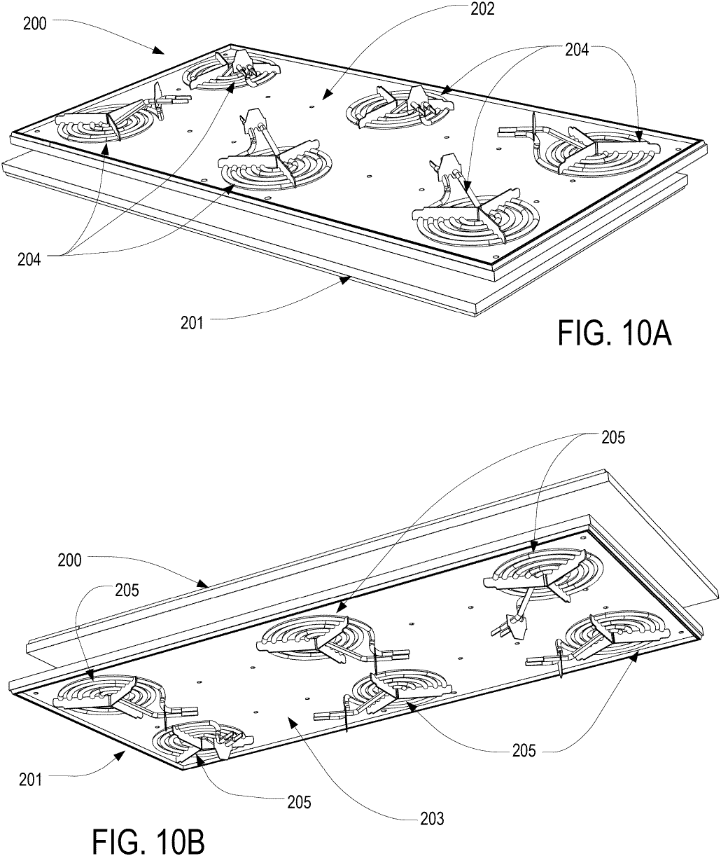

Referring next to FIG. 5, shown is a cross sectional view of the apparatus in order to illustrate some internal features not immediately apparent from a external views. As can be seen here, a top belt heating assembly (200) is positioned directly above the lower surface of the top belt (118) to provide the heat necessary to cook (or heat) the top surface of the sandwich or food item as it travels through the apparatus. Similarly, a bottom belt heating assembly (201) is positioned directly below the upper surface of the bottom belt (103) to provide the heat necessary to cook (or heat) the bottom surface of the sandwich or food item as it travels through the apparatus. Further details about the heating assemblies (200, 201) are provided below and in FIGS. 10A and 10B.

As will be observed while the top and bottom belts (118,103) each travel on an endless loop, the travel path of the belts on the unheated side of each loop is not straight. The top portion of the top belt (118) loop winds through two top belt tensioning rollers (125, 126), which, in turn, are restrained by a top belt tensioning turnbuckle (127), and a top belt tensioning spring (128). It will be observed that tension can be added and removed from the top belt (118) by turning the top belt tensioning turnbuckle (127). These adjustments can be made, for example, to remove and replace the top belt (118) or to optimize the operation of the top belt rollers (116, 117).

Similarly, the bottom portion of the bottom belt (103) loop winds through two bottom belt tensioning rollers (128, 129), which, in turn, are restrained by a bottom belt tensioning turnbuckle (130), and a bottom belt tensioning spring (131). It will be observed that tension can be added and removed from the top belt (103) by turning the top belt tensioning turnbuckle (130). These adjustments can be made, for example, to remove and replace the bottom belt (103) or to optimize the operation of the top belt rollers (112, 113).

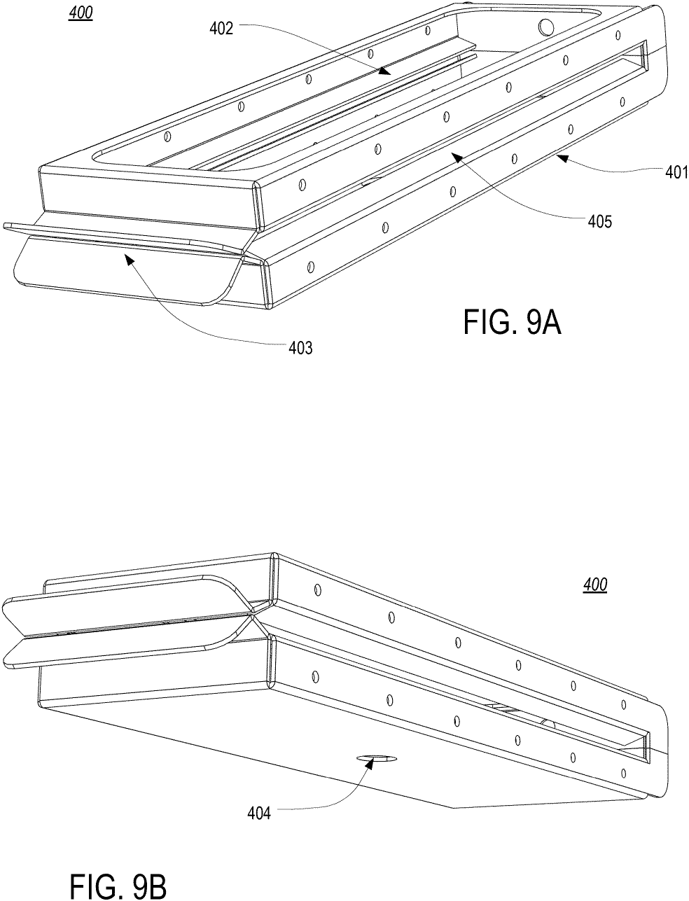

Also shown on FIG. 5 are cleaner boxes (400) that may optionally be utilized in some embodiments of the invention. Cleaner boxes (400) comprise enclosures that can be placed at multiple locations of either the top or bottom belts (118,103) and include scraping features as well water inlets to provide for washing of the belt. Additional detail regarding the cleaner boxes are provided below and in FIGS. 9A and 9B. A water heater (111), shown in FIG. 2, can optionally provide hot water to be used as a cleaning fluid by the cleaner boxes (400).

Referring next to FIG. 6, shown is a close-up view of the drive elements of the present invention with panels, covers, and some components removed for added clarity. Motor (123) directly rotates motor sprocket (140) which, in turn, drives lower belt sprocket (141) through lower drive chain (142). Bottom belt sprocket (141) is connected to, and directly drives, first bottom belt roller (112) and bottom belt (103). Transfer sprocket (146) is concentric with lower belt sprocket (141) and rotates simultaneously with it. Transfer sprocket (146), in turn drives forward sprocket (143) through transfer chain (150). Forward gear (144) is concentric with forward sprocket (143) and rotates simultaneously with it. Forward gear (144) engages reverse gear (145) which turns at the same speed, but in the opposite direction, as forward gear (144). Reverse sprocket (147) is concentric with reverse gear (145) and turns with it. Reverse sprocket (147), in turn, drives top belt sprocket (149) through top belt chain (148). Top belt sprocket (149) is connected to, and directly drives, first top belt roller (116) and top belt (118).

It will be observed that because transfer sprocket (146), forward sprocket (143), reverse sprocket (147), and top belt sprocket (149), all have the same number of teeth, top belt (118) and bottom belt (103) travel at the same speed but in opposite directions. Similarly, reverse gear (145) and forward gear (144) have the same number of teeth. Accordingly, the bottom surface of top belt (118) and the top surface of bottom belt (103) cooperate to smoothly transport a sandwich or other food item between the top and bottom belt heating assemblies (200, 201).

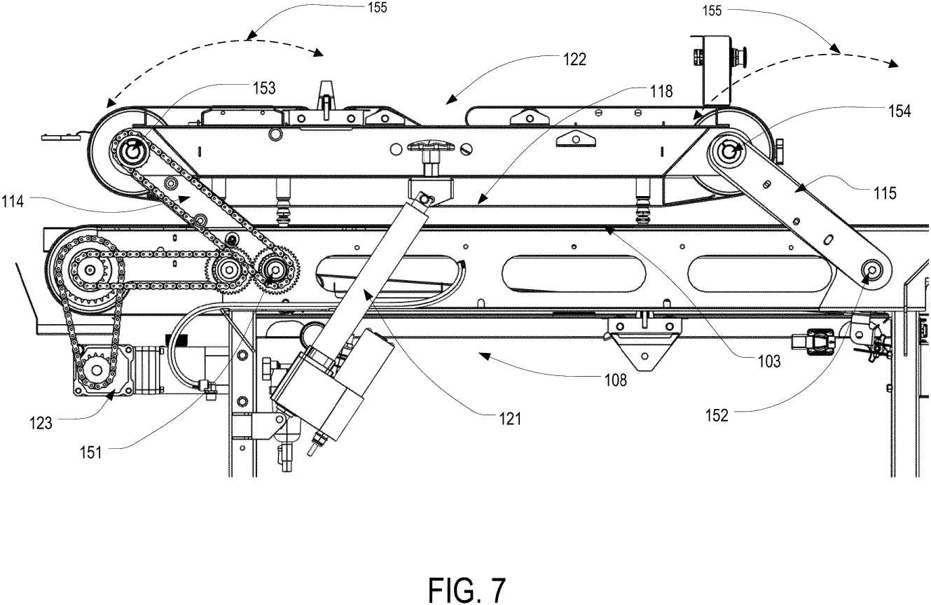

Referring next to FIG. 7, shown is a partial rear view representation of an embodiment of the present invention illustrating the swing motion for reversing the direction of the sandwich maker. First and second swing arms (114, 115) extend from the top portion of stand frame (108) to top belt assembly (122). On stand frame (108) first and second swing arms (114, 115) attach to first and second pivot points (151, 152). On the top belt assembly (122) first and second swing arms (114, 115) attach to first and second attachment points (153, 154). Upon extension of actuator (121), top belt assembly (122) will commence a swinging motion describing an arc (155) which elevates the top belt (118) with respect to the bottom belt (103). If the extension of the actuator (121) is sufficient to carry the first and second swing arms (114, 115) past the vertical position, the top assembly will begin lowering the top belt onto the bottom belt (103). Upon full extension of the actuator, the position of the top belt assembly (122) will be fully reversed, permitting operation of the apparatus in the opposite direction upon reversal of motor (123).

Referring next to FIGS. 8A and 8B, shown are orthographic top and cross-sectional views of a cleaner tank (300) in accordance with the present invention. Cleaner tank (300) comprises a triangularly profiled sink (or reservoir) (301), a handle assembly (302), one or more handle clips (306) to secure the handle to the sink (301), three or more rollers (303, 304, 305) adapted to receive and guide the top belt (118) or the bottom belt (103) through cleaning fluid (not shown) contained within the sink (301). Cleaner tank (300) is also equipped with a spout to easily pour out the cleaning fluid periodically so that fresh cleaning fluid can be added. It will be noted that the middle roller (305) is attached to handle (302) while the outer rollers (303, 304) are attached to the sink (301). In order to install cleaner tank (300) onto a belt (118, 103), the handle/middle roller assembly (302/305) is detached from sink (301) by releasing clip (306), the sink/outer roller assembly (310/303/304) is disposed below the belt (118, 103), and the handle/middle roller assembly (302/305) is disposed directly above the belt (118, 103). As the handle (302) and sink (301) are reassembled, the belt (118, 103) is “woven” between the rollers (303, 304, 305). Once the sink (301) is filled with cleaning fluid, the belt (118,103) will be cleaned as it travels through the cleaner tank (300). The cleaner tank (300) may also optionally include a scraper blade (not shown) to remove any large particles that may be lodged onto belt (118, 103).

Referring next to FIGS. 9A and 9B, shown are orthographic top and bottom views of a cleaner box (400) in accordance with the present invention. Cleaner box (400) comprises an enclosure (401) that can be placed at multiple locations of either the top or bottom belts (118,103) and include scraping features as well water inlets to provide for washing of the belt. Cleaner box enclosure (401) includes angled belt slots (405) with internal scrapers (402), as well as an angled edge belt entry (403). Belt entry (403) conveniently enables the installation and removal of cleaner box (400) on a belt while the apparatus is in operation and without the need to disassembly. The bottom part of cleaner box (400) includes an inlet (404) through which high pressure and/or high temperature cleaning fluid can be introduced to provide enhanced cleaning.

Referring next to FIGS. 10A and 10B, shown are orthographic views of top and bottom heating assemblies (200, 201) in accordance with the present invention. (200). Each of the heating assemblies comprises a heating plate (202, 203) that is adjacent to one or more individually controllable heating assemblies (204, 205). The heating assemblies can be resistive wire (shown), ceramic, optical (heat lamp), and can optionally be arranged in an array. The use of multiple heating elements per assembly allows for fine adjustment of temperatures by the controller as necessary to ensure optimal cooking of the food items.

Some embodiments of the described invention are equipped with one or more network interfaces (e.g., ethernet, WiFi, and similar known networking interfaces) so as to enable a remote computer to monitor the operation of the sandwich maker and to remotely interface with the control panel and controller. Said remote monitoring and interfacing can be enabled through computers located on the same private network as the sandwich maker, or through the internet or other similar public network.

Electrical power for all electrical components, including the heating assemblies (200, 201), water heater (111), motor (123), controller, camera (109), camera lights (110), and control panel and screen (106) can be provided as standard AC or DC line power, through a generator, solar power, standard converter, power supply, or similar devices widely available at commercial and/or home kitchens.

In addition, various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

We claim:

1. A sandwich maker comprising:
a top continuous loop conveyor belt having an outside surface;
a top heating plate associated with said top continuous loop conveyor belt and adapted to heat a lower portion of said outside surface of said top continuous loop conveyor belt;
a bottom continuous loop conveyor belt having an outside surface;
a bottom heating plate associated with said bottom continuous loop conveyor belt and adapted to heat an upper portion of said outside surface of said bottom continuous loop conveyor belt;
a motor adapted for simultaneously driving said top continuous loop conveyor belt in a first direction and said bottom continuous loop conveyor belt in a second direction, said second direction being the opposite of said first direction;
a controller in electronic communication with said motor, said top heating plate, and said bottom heating plate, the controller adapted to control a speed and a direction of said motor, a temperature of said top heating plate, and a temperature of said bottom heating plate;
a control panel adapted to interface with said controller;
wherein said lower portion of said outside surface of said top continuous loop conveyor belt and said upper portion of said outside surface of said bottom continuous loop conveyor belt are disposed opposite each other and are separated by a gap;
wherein said gap is adapted to receive a sandwich;
wherein said lower portion of said outside surface of said top continuous loop conveyor belt and said upper portion of said outside surface of said bottom continuous loop conveyor belt are adapted to transport said sandwich across said top heating plate and said bottom heating plate, simultaneously heating a top surface of said sandwich and a bottom surface of said sandwich; and
wherein said lower portion of said outside surface of said top continuous loop conveyor belt and said upper portion of said outside surface of said bottom continuous loop conveyor belt are also adapted to compress said sandwich as it is heated.
